(19) United States
(12) Patent Application Publication
(10) Pub. No.: US 2013/0093798 A1
(43) Pub. Date: Apr. 18, 2013

(54) LIQUID CRYSTAL DISPLAY DEVICE AND SIGNAL DRIVING METHOD FOR THE SAME

(71) Applicant: Chihtsung Kang, Shenzhen (CN)

(72) Inventor: Chihtsung Kang, Shenzhen (CN)

(73) Assignee: SHENZHEN CHINA STAR OPTOELECTRONICS TECHNOLOGY CO., LTD., Shenzhen (CN)

(21) Appl. No.: 13/375,447

(22) PCT Filed: Oct. 13, 2011
(86) PCT No.: PCT/CN2011/080721

§ 371 Date: Nov. 30, 2011

(30) Foreign Application Priority Data
Oct. 12, 2011 (CN) 20110308409.6

(51) Int. Cl. G09G 3/36; G09G 5/10

(52) U.S. Cl. 345/690; 345/89

(57) ABSTRACT

The present invention provides a liquid crystal display (LCD) device. By means of pre-charging in one frame and cooperating with the high or low signals of an array of the common lines, the LCD device can utilize a high voltage to pre-charge the pixels before writing correct gray scale signals into the pixels, i.e. executing an over-driving before writing the correct gray scale signals into the pixels. The present invention further provides a signal driving method for the LCD device. In comparison with the conventional technology, a frame buffer is not required for the present invention, thereby saving the cost. In addition, a complicated timing function is not required to the present invention for over-driving.

### FIELD OF THE INVENTION

The present invention relates to a display field, and more particularly to a liquid crystal display (LCD) device and a signal driving method for the same.

### BACKGROUND OF THE INVENTION

An over-driving method is a technology used for improving a display effect of an LCD panel. A conventional over-driving technology generally utilizes a look-up table to find a predetermined interpolated voltage values by means of comparing two sequential image signals for raising a response speed. In this method, a frame buffer is required to store a previous image which is used for being compared, and the above-mentioned predetermined interpolated voltage values is required to be stored in a storage device. In addition, a cooperation of a time control register (TCON) is also required.

In general, the over driving is achieved by using a row driving as shown in FIG. 1. When a driving signal of an original pixel is switched from 1V to 3V, for raising the response speed, a signal of 5V is generally inserted into the original driving signal (a common electrode voltage of common lines is set as 5V), and it is required to spend a frame time for charging. In this frame, a voltage of a gray scale signal of data lines is fell to 0V such that the driving signal of the pixel is 5V (without displaying in this frame), and the cooperation of the frame buffer is also required.

That is realized in a row driving is shown in FIG. 1, in which a common electrode voltage of common lines is set as 5V, and an original signal is switched from 1V (voltages of positive and negative polarities are respectively 6V and 4V) to 3V (voltages of the positive and negative polarities are respectively 8V and 2V). In order to increase the response speed, a signal 5V (voltages of the positive and negative polarities are respectively 10V and 0V) is generally inserted into the original signal. When a voltage in a pixel is changed from 1V to 3V, there is a frame time required to charge the pixel to get the 5V voltage.

In view of a patterned vertical alignment (PVA) panel, if only a look-up table of interpolation is applied, a waveform that a low gray-scale is switched to a high grayscale has a shape like a rhino horn which decreases the display effect. In order to achieve a high penetration, a designed pitch of strip electrodes in a pixel electrode is quite large, resulting in incorrect twist angles of liquid crystals which are driven instantaneously.

As a result, it is necessary to provide an LCD device and a signal driving method for the same to solve the problems existing in the conventional technologies, as described above.

### SUMMARY OF THE INVENTION

The present invention provides an LCD device and a signal driving method for the same capable of over-driving in one frame without using the frame buffer, so as to the problems existing in the conventional technologies that the over-driving can not be executed in one frame, and the frame buffer is required to store data, and the display effect is poor.

The present invention provides an LCD device, wherein the LCD device comprises: a scanning driver module for generating scanning signals; a data driver module for generating data signals; a plurality of pixels comprising a plurality of sub-pixels which are formed by a plurality of scanning lines and a plurality of data lines in crossed relationship, wherein the scanning lines are connected to the scanning driver module, and each of the scanning lines is connected to the sub-pixels in the same row for transmitting the scanning signals to the sub-pixels in the same row in sequence, and the data lines are connected to the data driver module, and each of the data lines is alternately connected to the sub-pixels having the same polarity at both sides thereof for transmitting gray scale signals to the sub-pixels; and a plurality of common lines for applying common voltages; wherein, in each frame, before transmitting the gray scale signals from the data lines to the sub-pixels, the sub-pixels are pre-charged by the gray scale signals according to a polarity of the sub-pixels and the common voltages corresponding to the sub-pixels; wherein, when the polarity of the sub-pixels is positive, a magnitude of a voltage for pre-charging the sub-pixels is controlled by a difference between the voltage of the gray scale signals of the data lines and the common voltages; wherein, when the polarity of the sub-pixels is negative, the magnitude of the pre-charging voltage is controlled by the difference between the voltage of the gray scale signals of the data lines and the common voltages; wherein, before transmitting the gray scale signals to the sub-pixels, gate electrodes of the sub-pixels are turned on by the scanning signals such that the sub-pixels are pre-charged by the gray scale signals; wherein, after transmitting the gray scale signals to the sub-pixels, the gate electrodes of the sub-pixels are turned off by the scanning signals such that the gray scale signals are displayed by the sub-pixels; wherein, when the gate electrodes of the sub-pixels are turned off by the scanning signals, the gate electrodes of the sub-pixels of a subsequent row are turned on, and the sub-pixels of the subsequent row are pre-charged by the gray scale signals.

The present invention provides an LCD device, wherein the LCD device comprises: a scanning driver module for generating scanning signals; a data driver module for generating data signals; a plurality of pixels comprising a plurality of sub-pixels which are formed by a plurality of scanning lines and a plurality of data lines in crossed relationship, wherein the scanning lines are connected to the scanning driver module, and each of the scanning lines is connected to the sub-pixels in the same row for transmitting the scanning signals to the sub-pixels in the same row in sequence, and the data lines are connected to the data driver module, and each of the data lines is alternately connected to the sub-pixels having the same polarity at both sides thereof for transmitting gray scale signals to the sub-pixels; and a plurality of common lines for applying common voltages; wherein, in each frame, before transmitting the gray scale signals from the data lines to the sub-pixels, the sub-pixels are pre-charged by the gray scale signals according to a polarity of the sub-pixels and the common voltages corresponding to the sub-pixels.

In the LCD device of the present invention, a magnitude of a voltage for pre-charging the sub-pixels is controlled by a difference between the voltage of the gray scale signals of the data lines and the common voltages when the polarity of the sub-pixels is positive, and the magnitude of the pre-charging voltage is controlled by the difference between the voltage of the gray scale signals of the data lines and the common voltages when the polarity of the sub-pixels is negative.

In the LCD device of the present invention, before transmitting the gray scale signals to the sub-pixels, gate electrodes of the sub-pixels are turned on by the scanning signals such that the sub-pixels are pre-charged by the gray scale signals.

In the LCD device of the present invention, after transmitting the gray scale signals to the sub-pixels, the gate electrodes of the sub-pixels are turned off by the scanning signals such that the gray scale signals are displayed by the sub-pixels.

In the LCD device of the present invention, when the gate electrodes of the sub-pixels are turned off by the scanning signals, the gate electrodes of the sub-pixels of a subsequent row are turned on, and the sub-pixels of the subsequent row are pre-charged by the gray scale signals.

In the above-mentioned LCD device, two adjacent rows of the sub pixels have two opposite polarities in a scanning time of each frame.

In the above-mentioned LCD device, waveforms of the common voltages of the two adjacent common lines are symmetrical.

Another object of the present invention is to provide a signal driving method for an LCD device, wherein the LCD device comprises a scanning driver module, a data driver module, scanning lines, data lines, common lines and pixels, and the pixels comprise a plurality of sub-pixels which are formed by the scanning lines and the data lines in crossed relationship, and the method comprises the following steps: S1. utilizing the scanning driver module to generate scanning signals and transmit the scanning signals to the scanning lines; S2. utilizing the data driver module to generate gray scale signals and transmit the gray scale signals to the data lines; S3. utilizing the scanning lines to transmit the scanning signals to the sub-pixels, wherein the scanning signals scan the sub-pixels in the same row in sequence; S4. utilizing the common lines to transmit common voltages; S5. utilizing the gray scale signals to pre-charge the sub-pixels according to a polarity of the sub-pixels and the common voltages corresponding to the sub-pixels, and then inputting the gray scale signals to the sub-pixels.

In the above-mentioned signal driving method for the LCD device, the step S5 comprises: when the polarity of the sub-pixels is positive, controlling a magnitude of a voltage for pre-charging the sub-pixels by means of a difference between the voltage of the gray scale signals of the data lines and the common voltages; and when the polarity of the sub-pixels is negative, controlling the magnitude of a voltage for pre-charging the sub-pixels by means of the difference between the voltage of the gray scale signals of the data lines and the common voltages.

In the above-mentioned signal driving method for the LCD device, the step S5 comprises: S51, before transmitting the gray scale signals to the sub-pixels, utilizing the scanning signals to turn on gate electrodes of the sub-pixels for utilizing the gray scale signals to pre-charge the sub-pixels.

In the above-mentioned signal driving method for the LCD device, after the step S51, the step S5 comprises: S52, after transmitting the gray scale signals to the sub-pixels, utilizing the scanning signals to turn off the gate electrodes of the sub-pixels for utilizing the sub-pixels to display the gray scale signals.

In the above-mentioned signal driving method for the LCD device, after the step S52, the step S5 comprises: S53. when the gate electrodes of the sub-pixels are turned off by the scanning signals, utilizing the scanning signals to turn on the gate electrodes of the sub-pixels of the subsequent row, and utilizing the gray scale signals to pre-charge the sub-pixels of the subsequent row.

In the above-mentioned signal driving method for the LCD device, two adjacent rows of the sub pixels have two opposite polarities in a scanning time of each frame.

In the above-mentioned signal driving method for the LCD device, waveforms of the common voltages of the two adjacent common lines are symmetrical.

The beneficial effects of the present invention are that, in comparison with the conventional technology, the frame buffer is not required for the present invention, thereby saving the cost, and a complicated timing function is not required to the present invention for over-driving, and in comparison with utilizing the look-up table to comparing two sequential image signals for over-driving, the method of the present invention can greatly prevent the incorrect twist angles of liquid crystals which are driven instantaneously.

The structure and the technical means adopted by the present invention to achieve the above-mentioned and other objects can be best understood by referring to the following detailed description of the preferred embodiments and the accompanying drawings.

### DESCRIPTION OF THE DRAWINGS

FIG. 1 is a schematic diagram showing a conventional over-driving in a row driving;

FIG. 2 is a block diagram illustrating the LCD device of the present invention;

FIG. 3 is a partial schematic diagram illustrating the LCD device according to one embodiment of the present invention; and

FIG. 4 is a schematic diagram illustrating a signal driving of the LCD device according to the present invention.

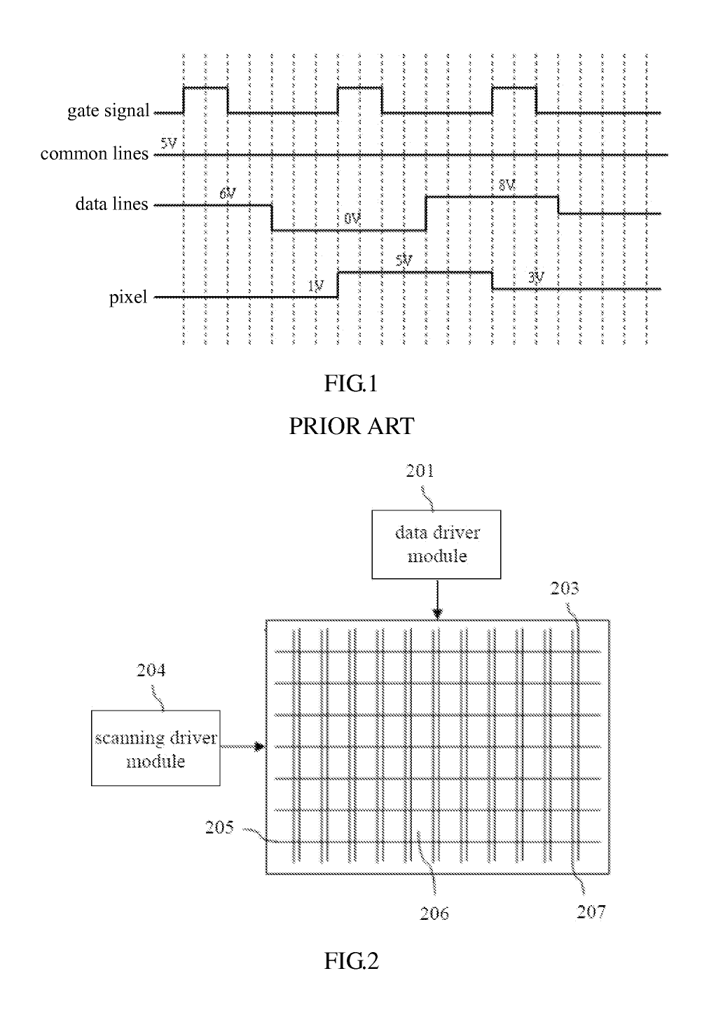

### DETAILED DESCRIPTION OF THE PREFERRED EMBODIMENTS

The following embodiments are referring to the accompanying drawings for exemplifying specific implementable embodiments of the present invention. Furthermore, directional terms described by the present invention, such as upper, lower, front, back, left, right, inner, outer, side and etc., are only directions by referring to the accompanying drawings, and thus the used directional terms are used to describe and understand the present invention, but the present invention is not limited thereto.

In the drawings, structure-like elements are labeled with like reference numerals.

The LCD device of the present invention employs pre-charging within a frame accompanying high and low levels signals of an array common (Array Com) lines. Each pixel is pre-charged by a high voltage before writing a gray scale signal therein, that is, an over driving is performed before the scale signal is written into the pixel.

Referring to FIG. 2, FIG. 2 is a block diagram illustrating the LCD device of the present invention. The LCD device of the present invention comprises a scanning driver module 204, a data driver module 201, a plurality of scanning lines (gate lines) 205, a plurality of common lines 203, a plurality of data lines 207 and a plurality of pixels 206. As shown in FIG. 2, the common lines 203 are arranged parallel to the data lines 207, and the common lines 203 are vertical to the scanning lines 205. Each of the pixels 206 comprises three sub-pixels which are not shown in FIG. 2. The scanning driver module 204 is utilized to generate scanning signals, and the scanning signals are transmitted to the scanning lines 205 by the scanning driver module 204. The data driver module 201 is utilized to generate gray scale signal, and the gray scale signal are transmitted to the data lines 207 by the data driver module 201. The scanning lines 205 are connected to the pixels 206. Specifically, each of the scanning lines 205 is connected to the sub-pixels in the same row. Specifically, each of the data line 207 is connected to the sub-pixels having the same polarity at both sides thereof. The common lines 203 are connected to the pixels 206. Specifically, each of the common lines 203 is connected to sub-pixels in the same column. Before transmitting the gray scale signals from the data lines 207 to the sub-pixels, the sub-pixels are pre-charged by the gray scale signals according to a polarity of the sub-pixels and the common voltage corresponding to the sub-pixels.

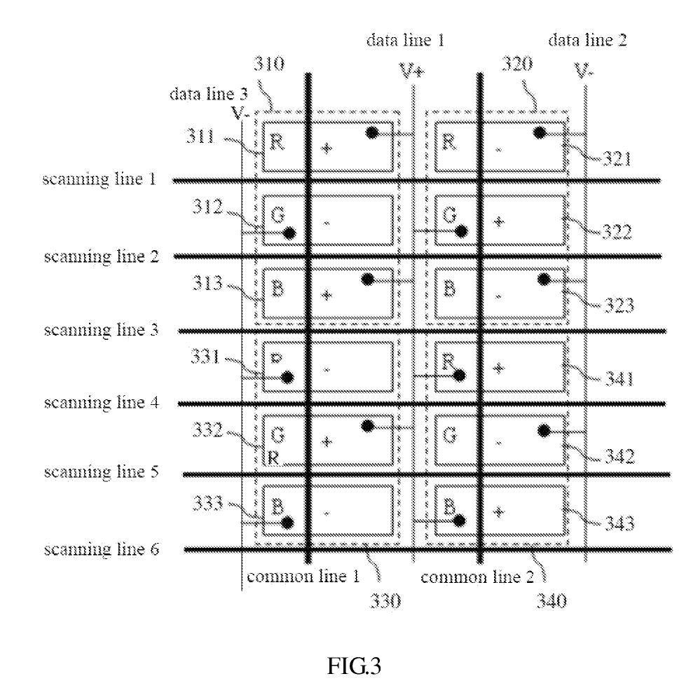

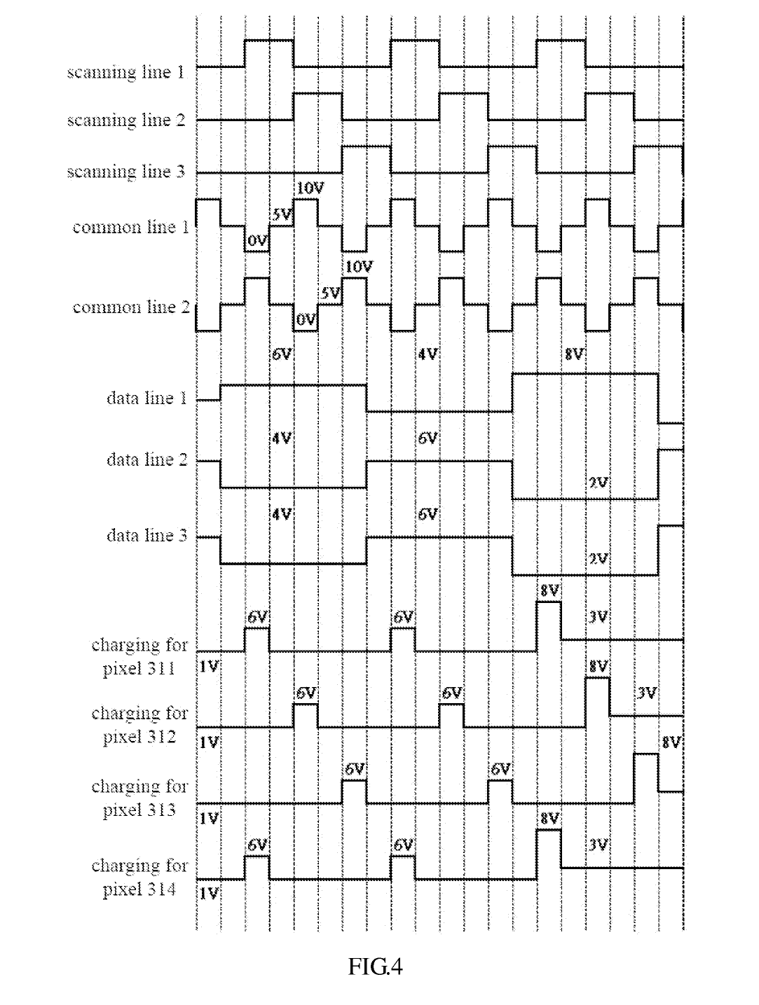

Referring to FIG. 3 and FIG. 4, FIG. 3 is a partial schematic diagram illustrating the LCD device according to the present invention, and FIG. 4 is a schematic diagram illustrating a signal driving of the LCD device according to an embodiment of the present invention. In this embodiment, each of the pixel is composed of three sub-pixels (a sub-pixel R, a sub-pixel G, and a sub-pixel B). In the LCD device of the present invention, the scanning signals of the scanning lines sequentially are utilized to scan longitudinally each of the sub-pixels which are arranged in the same row. The data lines are arranged along the arrangement of the sub pixel R, the sub pixel G and the sub pixel B. In this embodiment, in a scanning time of each frame, two adjacent rows of the sub pixels in the same pixel have two opposite polarities, and two adjacent rows of the sub pixels in different pixels also have the opposite polarities, and waveforms of the common voltages of the two adjacent common lines are symmetrical.

The data lines (including a data line 1, a data line 2 and a data line 3) are alternatively connected to the sub pixels having the same polarity of both sides thereof. Specifically, the data line 1 is connected to the sub pixels R311 and B313 having the positive polarity in a first pixel 310, the sub pixel G322 having the positive polarity in a second pixel 320, the sub pixel G332 having the positive polarity in a third pixel 330 and the sub pixels R341 and B343 having the positive polarity in a fourth pixel 340. The data line 2 is connected to the sub-pixels R321 and B323 having the negative polarity in the second pixel 320, and the sub-pixel G342 having the negative polarity in the fourth pixel 340 (the other sub-pixels having the negative polarity are not shown). The data line 3 is connected to the sub-pixel G312 having the negative polarity in the first pixel 310, and the sub-pixels R331 and B333 having the negative polarity in the third pixel 330.

The common lines (including a common line 1 and a common line 2) are connected to the sub-pixels in the same row. Specifically, the common line 1 (com 1) is connected to the sub-pixels R311, G312, B313 in the first pixel 310, and the sub-pixels R331, G332, B333 in the third pixel 330. The common line 2 (com 2) is connected to the sub-pixels R321, G322, B323 in the second pixel 320, and the sub-pixels R341, G342, B343 in the fourth pixel 340.

As shown in FIG. 3, the sub-pixel R311 of the first pixel 310 and the sub-pixel R321 of the second pixel 320 are the sub-pixels in a first row, and the sub-pixel G312 of the first pixel 310 and the sub-pixel G322 of the second pixel 320 are the sub-pixels in a second row, and the rest can be done in the same manner. The common lines and the data lines are parallel to each other, and the common lines and the scanning lines (gate lines) are vertical to each other.

When the polarity of the sub-pixels is positive, a magnitude of the voltage for pre-charging the sub-pixels is controlled by a difference between the voltage of the gray scale signals of the data lines and the common voltage. When the polarity of the sub-pixels is negative, the magnitude of the pre-charging voltage is controlled by the difference between the voltage of the gray scale signals of the data lines and the common voltage.

As shown in FIG. 4, before raising the charging voltage in the sub-pixels from 1 V to 3 V, the pre-charging voltage of the gray scale signals in the same frame is raised from 6 V to 8 V, and thus it is not required to spend a frame time for charging the sub-pixels of the LCD device of the present invention. The above-mentioned charging voltage of 1 V for the sub-pixels can be formed by a voltage difference between the gray scale signals of 6 V and the common voltages of 5 V (the polarity of the sub-pixels is positive) or another voltage difference between the gray scale signals of 4 V and the common voltages of 5 V (the polarity of the sub-pixels is negative). The charging voltage of 3 V for the sub-pixels can be formed by a voltage difference between the gray scale signals of 8 V and the common voltages of 5 V (the polarity of the sub-pixels is positive) or another voltage difference between the gray scale signals of 2 V and the common voltages of 5 V (the polarity of the sub-pixels is negative). The pre-charging voltage of 6 V for the sub-pixels can be formed by a voltage difference between the gray scale signals of 6 V and the common voltages of 0 V (the polarity of the sub-pixels is positive) or another voltage difference between the gray scale signals of 4 V and the common voltages of 10 V (the polarity of the sub-pixels is negative). The pre-charging voltage of 8 V for the sub-pixels can be formed by a voltage difference between the gray scale signals of 8 V and the common voltages of 0 V (the polarity of the sub-pixels is positive) or another voltage difference between the gray scale signals of 2 V and the common voltages of 10 V (the polarity of the sub-pixels is negative).

Before transmitting the gray scale signals to the sub-pixels, gate electrodes of the sub-pixels are turned on by the scanning signals such that the sub-pixels are pre-charged by the gray scale signals. The scanning line 1 can transmit a high level signal to the gate electrodes of the sub-pixels of the first row (including the sub-pixel R311 of the first pixel 310 and the sub-pixel R321 of the second pixel 320), so as to turn on the gate electrodes of the active elements (such as TFTs) of the sub-pixels of the first row. Therefore, before raising the charging voltage of the sub-pixels of the first row (including the sub-pixel R311 of the first pixel 310 and the sub-pixel R321 of the second pixel 320) from 1V to 3V, the sub-pixels of the first row can be pre-charged by the pre-charging voltage of 8V (originally 6V) which is formed by the voltage difference between the gray scale signals of 8 V and the common voltages of 0 V (the polarity of the sub-pixels is positive) or another voltage difference between the gray scale signals of 2 V and the common voltages of 10 V (the polarity of the sub-pixels is negative). When the scanning line 1 transmits the high level signal to the gate electrodes of the sub-pixels of the first row, since the positive gray scale signals of the sub-pixel R311 of the first pixel 310 is 8V, and the common voltage of the common line 1 is lowered from 5V to 0V, the sub-pixel R311 of the first pixel 310 is pre-charged by a high voltage of 8V. At this time, the negative gray scale signals of the sub-pixel R321 of the second pixel 320 is 2V, and the common voltage of the common line 2 is 10V, and the sub-pixel R321 of the second pixel 320 is pre-charged by a high voltage of 8V.

After transmitting the gray scale signals to the sub-pixels, the gate electrodes of the sub-pixels are turned off by the scanning signals such that the gray scale signals are displayed by the sub-pixels. The common voltage of the common line 1 is raised from a low voltage of 0V to a normal common voltage of 5V, and the common voltage of the common line 2 is lowered from a high voltage of 10V to the normal common voltage of 5V. At this time, the high pre-charging voltage of 8V of the sub-pixel R311 of the first pixel 310 and the sub-pixel R321 of the second pixel 320 is reverted to a normal charging voltage of 3V for the pixels. Therefore, by means of raising the pre-charging voltage, the charging voltage of the normal pixels can be raised. Subsequently, the scanning line 1 can transmit a low voltage signal to the sub-pixels of the first row, so as to turn off the gate electrodes of the sub-pixels.

When the gate electrodes of the sub-pixels are turned off by the scanning signals, the gate electrodes of the sub-pixels of a subsequent row are turned on by the scanning signals, and the sub-pixels of a subsequent row are pre-charged by the gray scale signals. The scanning line 2 can transmit a high voltage signal to the gate electrodes of the sub-pixels of the second row (including the sub-pixel G312 of the first pixel 310 and the sub-pixel G322 of the second pixel 320), so as to turn on the gate electrodes of the sub-pixels of the second row. Similarly, before raising the charging voltage of the sub-pixels of the second row (including the sub-pixel G312 of the first pixel 310 and the sub-pixel G322 of the second pixel 320) from 1V to 3V, the sub-pixels of the second row can be pre-charged by the charging voltage of 8V which is formed by the voltage difference between the gray scale signals of 8 V and the common voltages of 0 V (the polarity of the sub-pixels is positive) or another voltage difference between the gray scale signals of 2 V and the common voltages of 10 V (the polarity of the sub-pixels is negative). When the scanning line 2 transmits the high level signal to the gate electrodes of the sub-pixels of the second row, since the negative signal of the sub-pixel G312 of the first pixel 310 is 2V, and the common voltage of the common line 1 is raised from 5V to 10V, the sub-pixel G312 of the first pixel 310 is pre-charged by a high voltage of 8V. At this time, the positive signal of the sub-pixel R322 of the second pixel 320 is 8V, and the common voltage of the common line 2 is 0V, and the sub-pixel G322 of the second pixel 320 is pre-charged by a high voltage of 8V.

Subsequently, the common voltage of the common line 1 is reverted from a high voltage of 10V to the normal common voltage of 5V, and the common voltage of the common line 2 is reverted from a low voltage of 0V to the normal common voltage of 5V. At this time, the high pre-charging voltage of 8V of the sub-pixel G312 of the first pixel 310 and the sub-pixel G322 of the second pixel 320 is reverted to the normal charging voltage of 3V for the pixels. The scanning line 2 can transmit a low voltage signal to the sub-pixels of the second row, so as to turn off the gate electrodes of the sub-pixels of the second row. Subsequently, the scanning line 3 can transmit a high voltage signal to the sub-pixels of a third row, so as to turn off the gate electrodes of the sub-pixels, and the rest can be done in the same manner, thereby achieving the over-driving in one frame.

By means of the connections and parameters between the sub-pixels, the scanning lines, the common lines and the data lines, the LCD device of the present invention can achieve the pre-charging for the sub-pixels in one frame. The specific voltages in the embodiments are not limited to the scope of the invention. The LCD device of the present invention can be applicable to the pre-charging using the gray scale signal of any voltage.

The present invention further relates to a signal driving method for the LCD device. The LCD device comprises the scanning driver module, the data driver module, the scanning lines, the data lines, the common lines and the pixels. The pixels comprise the plurality of sub-pixels which are formed by the scanning lines and the data lines in crossed relationship. The method comprises the following steps: S1. utilizing the scanning driver module to generate the scanning signals and transmit the scanning signals to the scanning lines; S2. utilizing the data driver module to generate the gray scale signals and transmit the gray scale signals to the data lines; S3. utilizing the scanning lines to transmit the scanning signals to the sub-pixels, wherein the scanning signals scan the sub-pixels in the same row in sequence; S4. utilizing the common lines to transmit the common voltages; and S5. utilizing the gray scale signals to pre-charge the sub-pixels according to the polarity of the sub-pixels and the common voltages corresponding to the sub-pixels, and then inputting the gray scale signals to the sub-pixels. In step S5, when the polarity of the sub-pixels is positive, a magnitude of a voltage for pre-charging the sub-pixels is controlled by a difference between the voltage of the gray scale signals of the data lines and the common voltages, and when the polarity of the sub-pixels is negative, the magnitude of the pre-charging voltage is controlled by the difference between the voltage of the gray scale signals of the data lines and the common voltages.

By means of pre-charging in one frame and cooperating with the high or low signals of an array of the common lines, the LCD device of the present invention and the signal driving method for the same can utilize a high voltage to pre-charge the pixels before writing the gray scale signals into the pixels, i.e. executing the over-driving before writing the gray scale signals into the pixels. Specifically, before transmitting the gray scale signals from the data lines to the sub-pixels, the sub-pixels are pre-charged by the gray scale signals according to the polarity of the sub-pixels and the common voltages corresponding to the sub-pixels. In that manner, by means of varying the pre-charging voltage for the sub-pixels, the over-driving for the sub-pixels using the gray scale signals of different voltages can be achieved.

In the preferred embodiment of the LCD device and the signal driving method for the same of the present invention, the step S5 comprises: S51. before transmitting the gray scale signals to the sub-pixels, utilizing the scanning signals to turn on the gate electrodes of the sub-pixels for utilizing the gray scale signals to pre-charge the sub-pixels; S52. after transmitting the gray scale signals to the sub-pixels, utilizing the scanning signals to turn off the gate electrodes of the sub-pixels for utilizing the sub-pixels to display the gray scale signals; and S53. when the gate electrodes of the sub-pixels are turned off by the scanning signals, utilizing the scanning signals to turn on the gate electrodes of the sub-pixels of the subsequent row, and utilizing the gray scale signals to pre-charge the sub-pixels of the subsequent row.

With the use of the above-mentioned method, the sub-pixels of different rows can be turn on or off sequentially for more stably and compactly pre-charging and displaying each of the sub-pixels, hence achieving the pre-charging for each sub-pixel in one frame.

The present invention has been described above with a preferred embodiment thereof, and it is understood that many changes and modifications to the described embodiment can be carried out without departing from the scope and the spirit of the invention that is intended to be limited only by the appended claims.

1. A liquid crystal display (LCD) device, characterized in that: the LCD device comprises:
a scanning driver module for generating scanning signals;
a data driver module for generating data signals;
a plurality of pixels comprising a plurality of sub-pixels which are formed by a plurality of scanning lines and a plurality of data lines in crossed relationship, wherein the scanning lines are connected to the scanning driver module, and each of the scanning lines is connected to the sub-pixels in the same row for transmitting the scanning signals to the sub-pixels in the same row in sequence, and the data lines are connected to the data driver module, and each of the data lines is alternately connected to the sub-pixels having the same polarity at both sides thereof for transmitting gray scale signals to the sub-pixels; and
a plurality of common lines for applying common voltages;
wherein, in each frame, before transmitting the gray scale signals from the data lines to the sub-pixels, the sub-pixels are pre-charged by the gray scale signals according to a polarity of the sub-pixels and the common voltages corresponding to the sub-pixels;
wherein, when the polarity of the sub-pixels is positive, a magnitude of a voltage for pre-charging the sub-pixels is controlled by a difference between the voltage of the gray scale signals of the data lines and the common voltages;
wherein, when the polarity of the sub-pixels is negative, the magnitude of the pre-charging voltage is controlled by the difference between the voltage of the gray scale signals of the data lines and the common voltages;
wherein, before transmitting the gray scale signals to the sub-pixels, gate electrodes of the sub-pixels are turned on by the scanning signals such that the sub-pixels are pre-charged by the gray scale signals;
wherein, after transmitting the gray scale signals to the sub-pixels, the gate electrodes of the sub-pixels are turned off by the scanning signals such that the gray scale signals are displayed by the sub-pixels;
wherein, when the gate electrodes of the sub-pixels are turned off by the scanning signals, the gate electrodes of the sub-pixels of a subsequent row are turned on, and the sub-pixels of the subsequent row are pre-charged by the gray scale signals.

2. An LCD device, characterized in that: the LCD device comprises:
a scanning driver module for generating scanning signals;
a data driver module for generating data signals;
a plurality of pixels comprising a plurality of sub-pixels which are formed by a plurality of scanning lines and a plurality of data lines in crossed relationship, wherein the scanning lines are connected to the scanning driver module, and each of the scanning lines is connected to the sub-pixels in the same row for transmitting the scanning signals to the sub-pixels in the same row in sequence, and the data lines are connected to the data driver module, and each of the data lines is alternately connected to the sub-pixels having the same polarity at both sides thereof for transmitting gray scale signals to the sub-pixels; and
a plurality of common lines for applying common voltages;
wherein, in each frame, before transmitting the gray scale signals from the data lines to the sub-pixels, the sub-pixels are pre-charged by the gray scale signals according to a polarity of the sub-pixels and the common voltages corresponding to the sub-pixels.

3. The LCD device according to claim 2, characterized in that: a magnitude of a voltage for pre-charging the sub-pixels is controlled by a difference between the voltage of the gray scale signals of the data lines and the common voltages when the polarity of the sub-pixels is positive, and the magnitude of the pre-charging voltage is controlled by the difference between the voltage of the gray scale signals of the data lines and the common voltages when the polarity of the sub-pixels is negative.

4. The LCD device according to claim 2, characterized in that: before transmitting the gray scale signals to the sub-pixels, gate electrodes of the sub-pixels are turned on by the scanning signals such that the sub-pixels are pre-charged by the gray scale signals.

5. The LCD device according to claim 4, characterized in that: after transmitting the gray scale signals to the sub-pixels, the gate electrodes of the sub-pixels are turned off by the scanning signals such that the gray scale signals are displayed by the sub-pixels.

6. The LCD device according to claim 5, characterized in that: when the gate electrodes of the sub-pixels are turned off by the scanning signals, the gate electrodes of the sub-pixels of a subsequent row are turned on, and the sub-pixels of the subsequent row are pre-charged by the gray scale signals.

7. The LCD device according to claim 2, characterized in that: in a scanning time of each frame, two adjacent rows of the sub pixels have two opposite polarities.

8. The LCD device according to claim 2, characterized in that: waveforms of the common voltages of the two adjacent common lines are symmetrical.

9. A signal driving method for an LCD device, characterized in that: the LCD device comprises a scanning driver module, a data driver module, scanning lines, data lines, common lines and pixels, and the pixels comprise a plurality of sub-pixels which are formed by the scanning lines and the data lines in crossed relationship, and the method comprises the following steps:
S1. utilizing the scanning driver module to generate scanning signals and transmit the scanning signals to the scanning lines;
S2. utilizing the data driver module to generate gray scale signals and transmit the gray scale signals to the data lines;
S3. utilizing the scanning lines to transmit the scanning signals to the sub-pixels, wherein the scanning signals scan the sub-pixels in the same row in sequence;
S4. utilizing the common lines to transmit common voltages;
S5. utilizing the gray scale signals to pre-charge the sub-pixels according to a polarity of the sub-pixels and the common voltages corresponding to the sub-pixels, and then inputting the gray scale signals to the sub-pixels.

10. The signal driving method for the LCD device according to claim 9, characterized in that: the step S5 comprises:
when the polarity of the sub-pixels is positive, controlling a magnitude of a voltage for pre-charging the sub-pixels by means of a difference between the voltage of the gray scale signals of the data lines and the common voltages; and
when the polarity of the sub-pixels is negative, controlling the magnitude of a voltage for pre-charging the sub-pixels by means of the difference between the voltage of the gray scale signals of the data lines and the common voltages.

11. The signal driving method for the LCD device according to claim 9, characterized in that: the step S5 comprises:
S51. before transmitting the gray scale signals to the sub-pixels, utilizing the scanning signals to turn on gate electrodes of the sub-pixels for utilizing the gray scale signals to pre-charge the sub-pixels.

12. The signal driving method for the LCD device according to claim 11, characterized in that: after the step S51, the step S5 comprises:
S52. after transmitting the gray scale signals to the sub-pixels, utilizing the scanning signals to turn off the gate electrodes of the sub-pixels for utilizing the sub-pixels to display the gray scale signals.

13. The signal driving method for the LCD device according to claim 12, characterized in that: after the step S52, the step S5 comprises:
S53. when the gate electrodes of the sub-pixels are turned off by the scanning signals, utilizing the scanning signals to turn on the gate electrodes of the sub-pixels of the subsequent row, and utilizing the gray scale signals to pre-charge the sub-pixels of the subsequent row.

14. The signal driving method for the LCD device according to claim 9, characterized in that: in a scanning time of each frame, two adjacent rows of the sub pixels have two opposite polarities.

15. The signal driving method for the LCD device according to claim 9, characterized in that: waveforms of the common voltages of the two adjacent common lines are symmetrical.
